(19) United States
(12) Patent Application Publication
(10) Pub. No.: US 2026/0068018 A1
(43) Pub. Date: Mar. 5, 2026

(54) PERMANENT OUTDOOR LIGHTING SYSTEM WITH APP-CONTROLLED ADDRESSABLE LEDS AND COLOR-MATCHED MOUNTING TRACK

(71) Applicant: Celebright Inc., Ottawa (CA)

(72) Inventor: Dan JUNKINS, Ottawa (CA)

(21) Appl. No.: 19/313,794

(22) Filed: Aug. 28, 2025

Related U.S. Application Data
(60) Provisional application No. 63/689,396, filed on Aug. 30, 2024.
(60) Provisional application No. 63/689,447, filed on Aug. 30, 2024.

(51) Int. Cl. H05B 47/175; F21S 8/00; F21V 23/04; F21V 23/06; F21V 31/00; F21W 131/107; F21Y 115/10; H05B 45/20; H05B 45/54; H05B 47/155; H05B 47/16; H05B 47/17; H05B 47/19; H05B 47/24; H05B 47/25

(52) U.S. Cl. CPC H05B 47/1985; F21S 8/036; F21V 23/0435; F21V 31/005; H05B 45/20; H05B 45/54; H05B 47/155; H05B 47/16; H05B 47/17; H05B 47/19; H05B 47/1965; H05B 47/24; H05B 47/25; F21V 23/06; F21W 2131/107; F21Y 2115/10

(57) ABSTRACT

The present disclosure relates to permanent outdoor lighting systems, specifically those utilizing app-controlled addressable LEDs. The invention covers the overall system architecture, including the communication method between the app, server, control box, and LED light sources, as well as the physical design of the LED mounting system, including a color-matched aluminum track.

### CROSS REFERENCE TO RELATED APPLICATIONS

This application claims priority to and the benefits of U.S. Provisional Application Ser. No. 63/689,396, entitled “PERMANENT OUTDOOR LIGHTING SYSTEM WITH APP-CONTROLLED ADDRESSABLE LEDS AND COLOR-MATCHED MOUNTING TRACK” filed on Aug. 30, 2024, and U.S. Provisional Application Ser. No. 63/689,447, entitled “SMART LIGHTING CONTROLLER OUTPUT SECTION WITH ENHANCED PROTECTION, LOW OUTPUT IMPEDANCE, AND EMISSIONS FILTERING” filed on Aug. 30, 2024, the disclosures of which are incorporated herein by reference in their entirety.

### BACKGROUND

The embodiments described herein relate to outdoor lighting, in particular, technologies related to power management for outdoor lighting.

Outdoor lighting systems are increasingly incorporating smart technology to offer enhanced control and customization. Traditional systems often lack the flexibility and ease of use provided by modern app-based controls. Additionally, integrating addressable LEDs into a weather-resistant, aesthetically pleasing system remains challenging. Most systems are also temporary and require the homeowner or business to have lights installed every holiday season.

Furthermore, smart lighting systems are becoming increasingly popular in both residential and commercial settings, offering flexibility, energy efficiency, and aesthetic appeal. Controllers are typically mounted in a garage or outside a building and wires from 5 to 100 ft connect power and data to smart LED strings on the roofline. The output sections of these controllers are often susceptible to damage from high voltage short circuits, signal degradation over long wiring runs, and electromagnetic interference (EMI) issues that can prevent compliance with regulatory standards such as FCC Class B emissions.

The present disclosure addresses these challenges by providing a comprehensive solution that combines advanced control features with durable, visually integrated hardware.

### SUMMARY

The present disclosure provides a permanent outdoor lighting system that mounts onto buildings or other structures. The system features addressable LED light sources controlled via an app. The app communicates with a server, which in turn sends commands to a control box connected to the local WiFi network. The control box transmits data to the LED lights over a 1-wire interface. The LED light sources are housed in round, waterproof casings and are mounted in an aluminum track, color matched to the home's architecture.

This present disclosure also covers a novel outdoor lighting system that integrates modern smart technology with durable, visually integrated hardware. The system is designed for permanent installation, offering customizable, app-controlled lighting solutions with a color-matched aluminum track for enhanced aesthetic appeal.

### BRIEF DESCRIPTION OF THE DRAWINGS

FIG. 1 depicts an exemplary interaction flow between the application, server, database, and lighting controller via the internet.

FIG. 2 provides a detailed view of the wiring connections between the controller and the lighting components, including an auxiliary unit containing additional Class 2 power supplies and the corresponding connections through an isolator circuit.

FIG. 3 demonstrates an example of the components on a physical structure.

FIG. 4 demonstrates the method of mounting an undermount aluminum track to the undermount structure.

FIGS. 5A to 5C are several screenshots of the application interface, including the color wheel, pattern selection options, and scheduling features.

FIGS. 6A to 6B are several screenshots of zones.

FIG. 7 shows a block diagram of the controller's data output section and their interconnection.

FIG. 8 shows the components used in protecting the output section from a short and describes the purpose of key components.

### DETAILED DESCRIPTION

The present disclosure relates to permanent outdoor lighting systems, specifically those utilizing app-controlled addressable LEDs. The disclosure covers the overall system architecture, including the communication method between the app, server, control box, and LED light sources, as well as the physical design of the LED mounting system, including a color-matched aluminum track.

### Features and Components of the System:

According to the disclosure, features and components of the system are as follows:

### App-Controlled Addressable LEDs:

The system includes an application (app) for mobile devices that allows users to control the colors and patterns of the LED lights and configure the lighting system. The app offers a user-friendly interface for selecting preset patterns, creating custom patterns, and adjusting brightness and color.

The mobile app is designed to interface with the remote server via the internet. The app allows users to select from a range of color patterns and lighting effects. Users can also create custom lighting patterns by selecting individual LEDs and assigning specific colors and effects. All these effects can be scheduled to run on at specific times of day and at repeating intervals.

### Server and Control Box Communication Architecture:

The app communicates with a remote server, which processes user inputs and sends corresponding commands to the control box. The control box is connected to the local WiFi network and serves as the hub for receiving commands from the server and sending them to the LED lights.

The server acts as an intermediary between the app and the control box. It processes user commands and translates them into data packets that are sent to the control box via WiFi. The control box decodes these packets and sends the appropriate signals to the LEDs via the 1-wire interface.

### 1-Wire Data Transmission Interface:

The control box sends data to the LED lights using a 1-wire protocol. This simplifies wiring and reduces the number of necessary connections, making installation easier and more cost-effective. The 1-wire interface used by the control box to communicate with the LEDs simplifies the wiring requirements of the system. This reduces installation time and cost, and also enhances the reliability of the system by minimizing the number of connections that could potentially fail. Data is transmitted by modulating the duration of pulses on the single data line.

Round Waterproof LED Light Sources Built into Light Strings:

The LED light sources are encapsulated in round, waterproof housings, making them suitable for permanent outdoor installation. The waterproof design ensures that the lights can withstand various weather conditions, including rain, snow, and UV exposure. The connectors between light strings are also waterproof.

### LED Light Source Design:

The round LED light sources are designed with a waterproof casing to ensure durability in outdoor environments. The LEDs are addressable, meaning each LED can be individually controlled to display a specific color and brightness. The waterproof design includes a sealing mechanism using potting compound and plastic enclosures that prevents water ingress, protecting the electronics. The addressable LED sources are built into light strings with between 1 and 18 LED sources.

### Color-Matched Aluminum Track Mounting System:

The LED light sources are mounted in an aluminum track that is closely color-matched to the house or structure on which it is installed. This track provides a secure, aesthetically pleasing mounting solution that blends seamlessly with the building's exterior. The track allows for consistent spacing of the LEDs at intervals of 6 to 24 inches, ensuring even lighting coverage.

The aluminum track is designed to be mounted onto the exterior of buildings or other structures. It is color-matched to blend seamlessly with the surface it is attached to, enhancing the overall aesthetic appeal. The track provides a stable base for the LED light sources, with predefined slots or channels for consistent spacing between the LEDs. The track system is designed for easy installation, with features that allow the lights to be snapped or slid into place.

### Powered Via Class-2 Power Supplies:

The control box and LED light sources are powered via class-2 power supplies because they are recognized for lower risk of fire. Class-2 power supplies can deliver not more than 100 VA of power under any load condition. If a system requires more than 100 VA additional supplies are used to power additional sections and the additional sections are electronically isolated from each other.

According to the disclosure, the system is powered from class-2 power supplies, as recognized by the NEC (National Electrical Code). When a system requires more than 100 VA of power, additional class-2 power supplies are used to provide the additional power demand. The sections of the system that are powered from different supplies are electronically isolated from each other. Communication data from the controller is passed between power sections via an opto-isolation circuit.

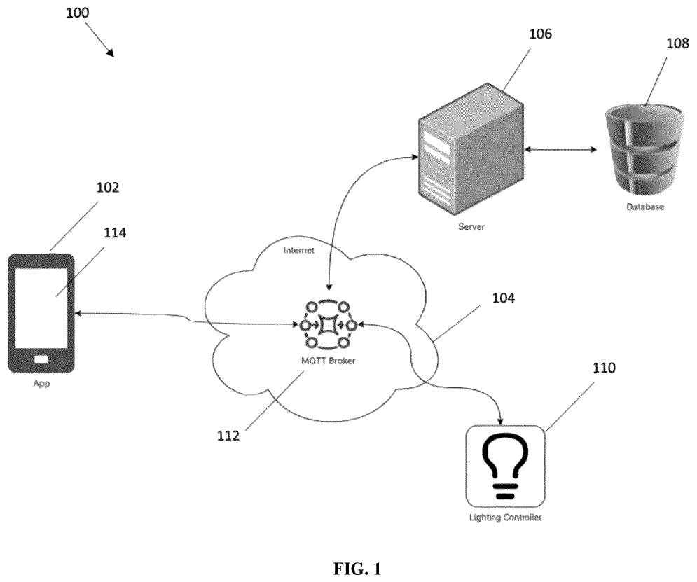

FIG. 1 depicts an exemplary interaction flow between the application, server, database, and lighting controller via the internet. According to FIG. 1, system 100 is shown having an application 114 on a mobile device 102. Mobile device 102 is connected to the internet 104 via an application service 112 (e.g., MQTT Broker). The internet 104 further connects the mobile application to a server 106 and a database 108. Furthermore, mobile application 102 is also connected to a lighting controller 110 via the internet 104.

According to FIG. 1, the MQTT broker is a central server in the publish/subscribe messaging model that receives messages from publishers (clients) and forwards them to other clients (subscribers) that are interested in a specific message “topic”. It acts as a central hub for communication between MQTT clients, ensuring reliable and efficient message delivery in lightweight applications such as the Internet of Things (IoT) and distributed systems.

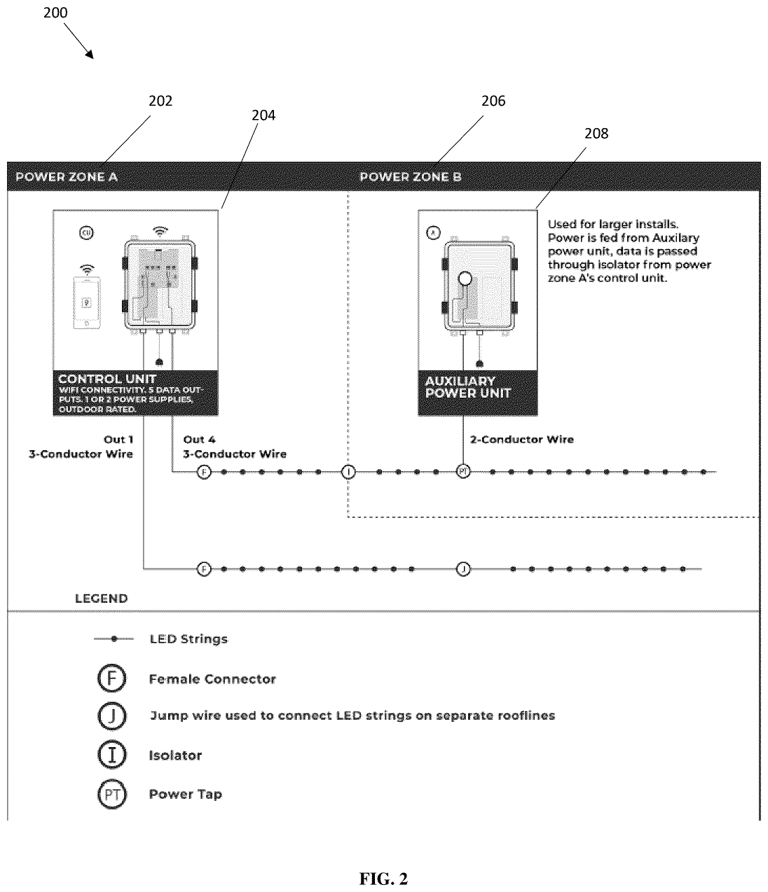

FIG. 2 provides a detailed view of the wiring connections between the controller and the lighting components, including an auxiliary unit containing additional Class 2 power supplies and the corresponding connections through an isolator circuit. According to FIG. 2, wiring connections diagram 200 is shown connected to two zones, Power Zone A 202 and Power Zone B 208).

According to FIG. 2, Power Zone A 202 consists of control unit 204 having Wifi Connectivity, 5 data outputs, 1 or 2 power suppliers and is also outdoor rated. The outputs of the control unit 204 are on 3-conductor wire and connects a female connector (F) to an LED string and an isolator circuit. A jump wire (J) may also be used to connect the LED strings to separate rooflines.

According to FIG. 2, Power Zone B 206 consists of an auxiliary power unit 208. Auxiliary power unit 208 is used for larger installs where power is fed from the auxiliary power unit and data is passed through the isolator circuit from control unit 204 (from Power Zone A). According to FIG. 2, power unit 208 utilizes a 2-conductor wire to connect two or more strings of LED lights.

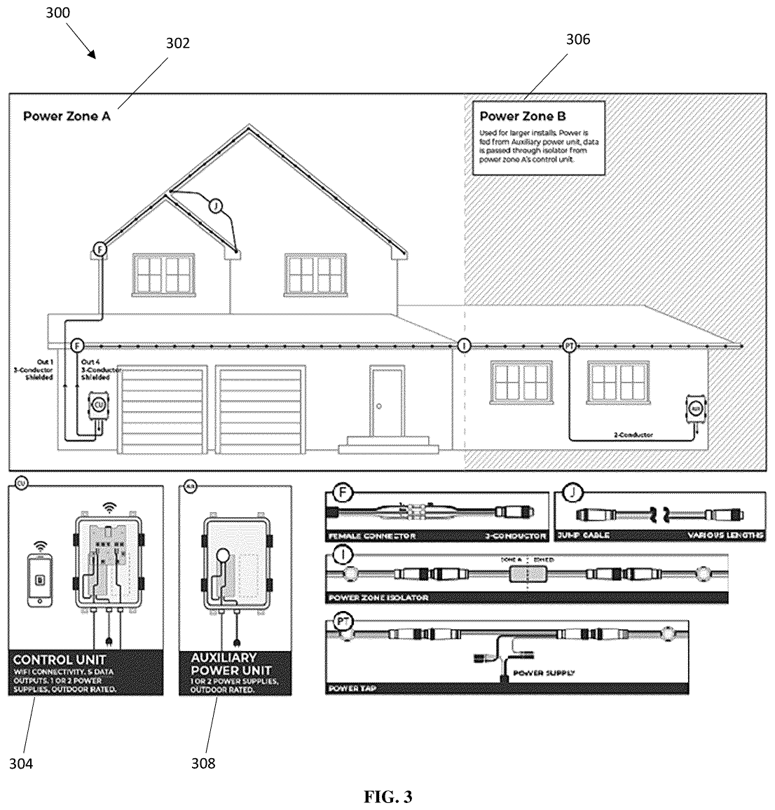

FIG. 3 demonstrates an example of the components on a physical structure. According to FIG. 3, example 300 shows a house with two Power Zones 302 and 306 (i.e., Power Zone A and B respectively). The main power zone 302 (i.e., Power Zone A) is controlled by control unit 304.

The secondary power zone 306 (i.e., Power Zone B) is controlled by auxiliary power unit 308; it is used for larger installs where power is fed from the auxiliary power unit and data is passed through the isolator circuit from control unit 304 (from Power Zone A). Furthermore, power unit 308 utilizes a 2-conductor wire to connect two or more strings of LED lights.

According to FIG. 3, control unit 304 connects to multiple LED light strings through connection F (i.e., female connector to 3-conductor connector), connection J (i.e., jump cable connector to various length connectors) and to connection I (i.e., power zone isolator). Auxiliary power unit 308 utilizes a 2-conductor wire to connect to a power tap connection (i.e., power tap connector to multiple power supplies) and to connection I (i.e., power zone isolator).

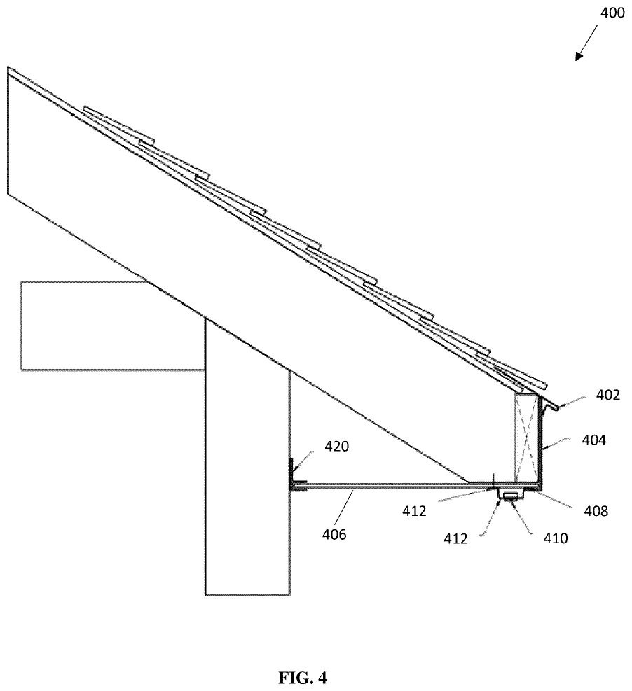

FIG. 4 demonstrates the method of mounting an undermount aluminum track to the undermount structure. According to FIG. 4 system 400 is shown having a drip edge 402, a fascia 404, soffit 406, an edge 408 tucked between fascia 404 and soffit 406, LED bulb 410, a standard ⅝ undermount track flange 412, screw 412 and F-channel 420. Screw 412 is drilled through track flange 412 and soffit 406. F-channel 420 is mounted to the side of the house.

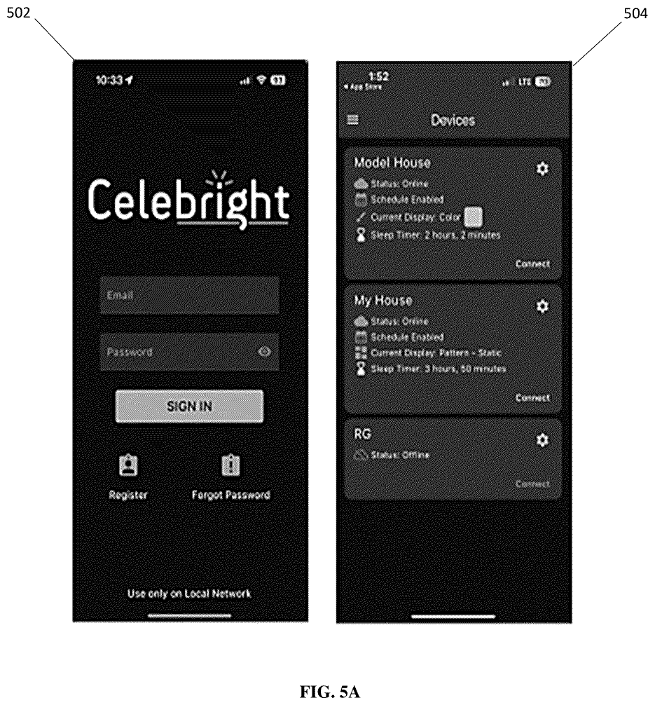

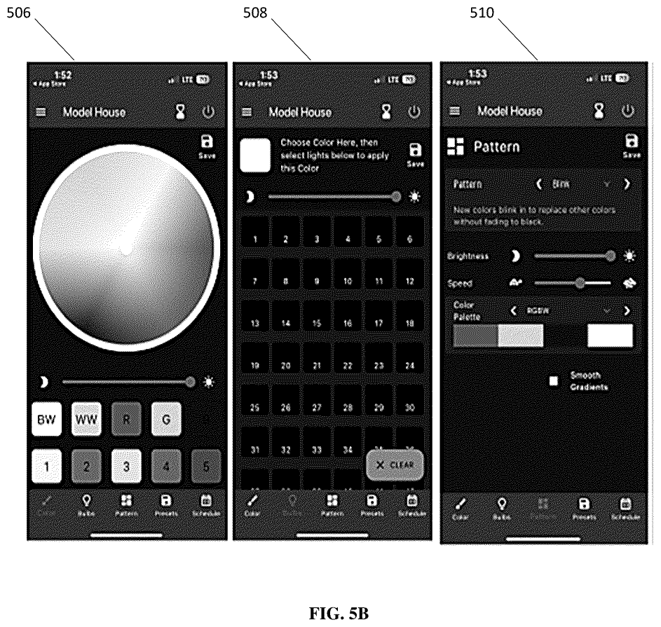

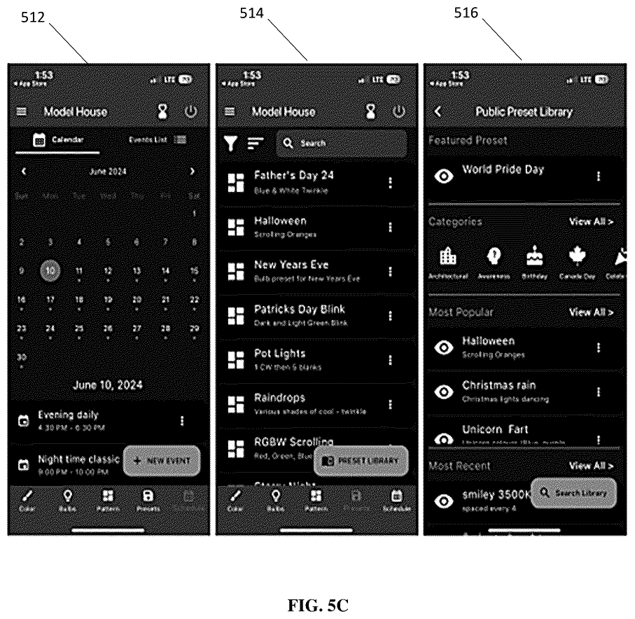

FIGS. 5A to 5C are several screenshots of the application interface, including the color wheel, pattern selection options, and scheduling features. According to FIG. 5A, screenshot 502 shows the initial sign in screen requesting the user email and password. There are further options to “Register” (for the first time) and to select “Forget Password” to reset the password.

According to FIG. 5A, screenshot 504 illustrates devices connected to the application interface including “Model House” and “My House” devices. Further option statuses for these devices including “Status”, “Schedule”, “Current Display” and “Sleep Timer” are also shown.

According to FIG. 5A, screenshot 506 shows a color wheel for “Model House” device. Screenshot 508 enables the user to choose the color of selected lights. Screenshot 510 enables the user to further configure pattern selection options.

According to FIG. 5C, screenshot 512 provides a calendar to assist in scheduling. Screenshots 514 and 516 are screenshots of events that can be set whereby the user can select different lighting options.

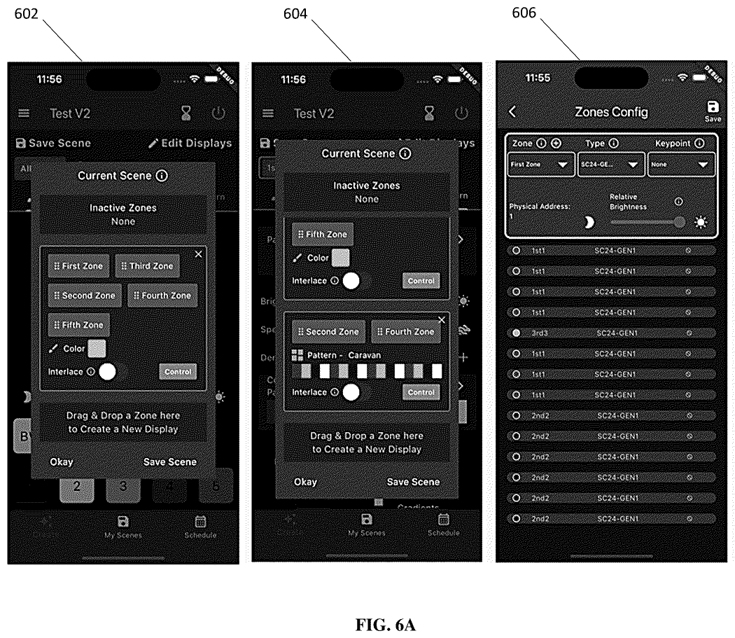

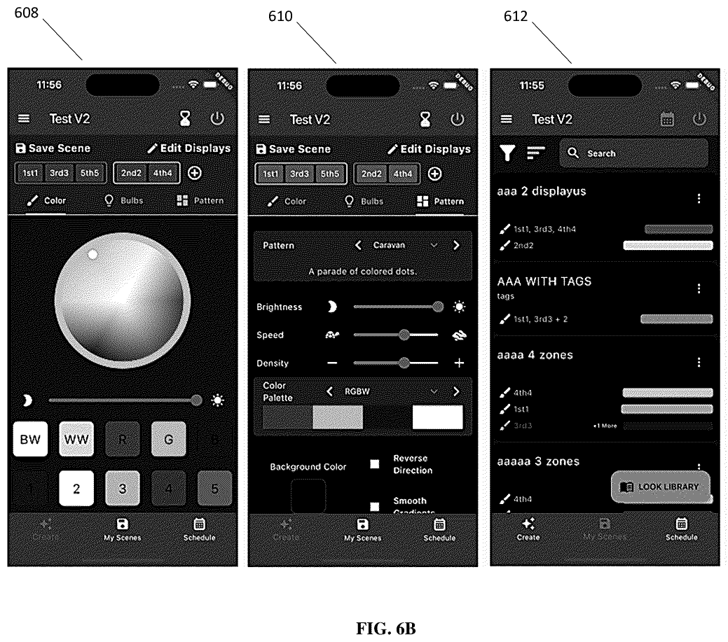

FIGS. 6A to 6B are several screenshots of zones. According to the disclosure FIGS. 6A and 6B, the zones functionality allows the app to essentially break up the installed lights into sections that can be controlled independently. For example, one can have the backyard with a constant color while the front yard is illuminated with a holiday pattern.

According to FIG. 6A, screenshots 602 and 604 illustrate the Current Scene with different zones that can be controlled. Screenshot 606 illustrates the Zones configuration. Screenshot 608 illustrates a color wheel to save a scene for a zone. Screenshot 610 illustrates other pattern settings such as brightness, speed and density for a scene for a zone. Screenshot 612 is a list view of the saved scene. A scene is a snapshot of a particular setting (e.g., color, bulb or pattern) which can be recalled at any time or scheduled to come on at a specific time.

In an embodiment, the app may allow the creation of one or more zones, which are virtual sections of lighting. Essentially, the zone functionality allows a certain subset of the lighting system (for example, lights 30 through 75) to be defined as a zone, which can then be programmed independently of the rest of the lighting string to display scenes, colors, patterns or other configurations of light. For example, if lights 1-29 were specified to be zone 1 and lights 30-75 were specified to be zone 2, each of these subsections of the lighting string could be controlled independently. For example, zone 1 may have a solid color, while zone 2 may show a chase pattern. Multiple zones may be created in a single lighting string, and any given zone may incorporate lights from one or more lighting strings.

In an embodiment, the app may have UI elements which allow the creation and deletion of zones. These may confirm that no light is an element of more than one zone. The app may have UI elements which can include one or more zones as part of a scene. The app may have UI elements to mark zones as active or inactive. The app may allow the treatment of a zone as a separate unit or virtual lighting string.

Smart Lighting Controller Output Section with Enhanced Protection, Low Output Impedance, and Emissions Filtering

The present disclosure also relates to lighting control systems, particularly to the output section of smart lighting controllers. This disclosure is designed to enhance the durability, performance, and regulatory compliance of lighting control systems, particularly those used in permanent holiday lighting setups or similar applications.

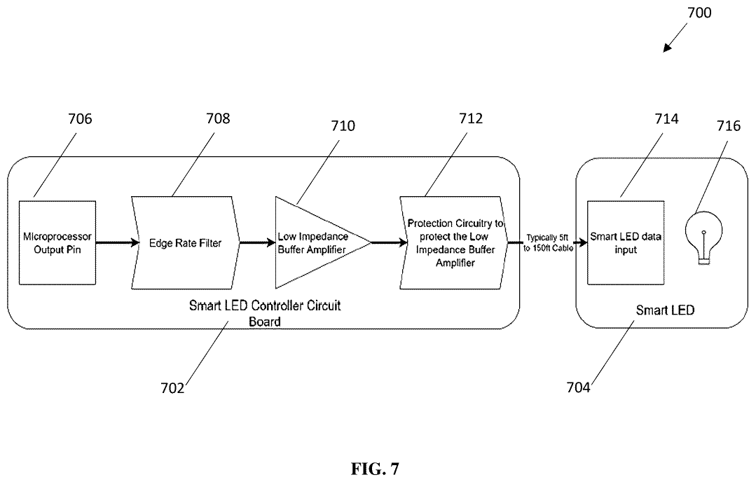

FIG. 7 shows a block diagram of the system components and their interconnection. According to FIG. 7, system 700 consists of a Smart LED controller circuit board 702 and a Smart LED 704. The Smart LED controller circuit board 702 further comprises a microprocessor output pin 706, an edge rate filter 708, a low impedance buffer amplifier 710 and protection circuitry 712. The protection circuitry 712 is used to protect the low impedance buffer amplifier 710.

According to FIG. 7, Smart LED further comprises a Smart LED data input 714 and a Smart LED bulb 716. The Smart LED controller circuit board 702 connects to Smart LED 704 by a cable ranging from 5 feet to 150 feet.

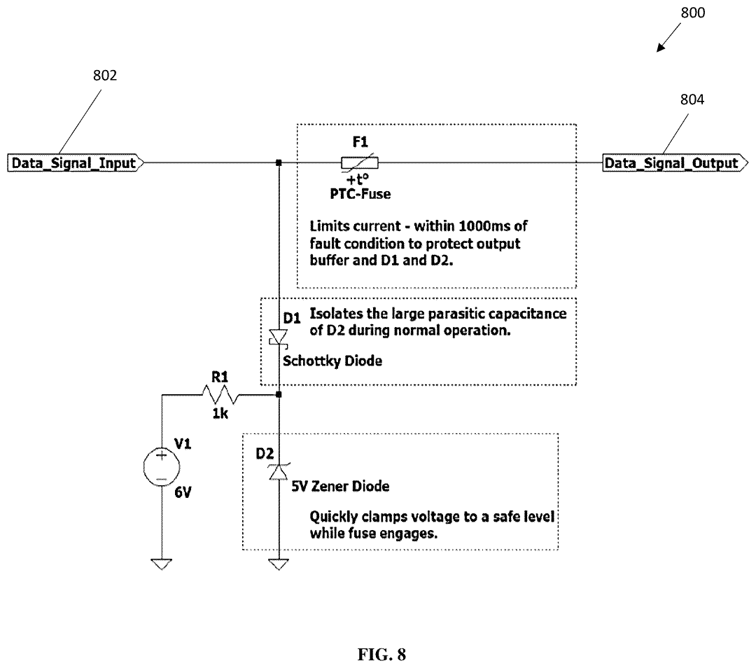

FIG. 8 shows the components used in protecting the output section from a short to a higher voltage, which may cause damage, and describes the purpose of key components. According to FIG. 8, diagram 800 comprises a data signal input line 802 connecting to data signal output line 804 by way of a PTC-Fuse F1.

According to FIG. 8, diagram 800 further comprises Schottky Diode D1 and 5V Zener Diode D2. Schottky Diode D1 isolates the larger parasitic capacitance of D2 during normal operation. The 5V Zener Diode D2. PTC-Fuse F1 limits the current withing 1000 ms of the fault condition to protect the output buffer and the Schottky Diode D1 and 5V Zener Diode D2.

According to FIG. 8, diagram 800 further comprises a 1K resistor R1 and a 6V voltage rail V1. V1 is the 6V voltage rail coming from a regulator on the controller of a printed circuit board (PCB).

### Features of the Smart Light Controller

The present disclosure provides an advanced output section for a smart lighting controller with the following key features:

Short Circuit Protection Mechanism with Voltage Shunting:

The output section incorporates a protection mechanism that prevents damage when the output line is shorted to a voltage higher than its operating range. This is achieved through a combination of fusing and a shunting mechanism that diverts instantaneous overvoltage to ground. The resettable fuse or polymeric positive temperature coefficient device (PPTC) acts to limit the amount of current in the event of excessive current flow, while the shunting mechanism provides immediate protection by redirecting the voltage spike away from sensitive components.

The output section is designed with a PPTC fuse rated to handle the normal operating current of the lighting system. In the event of a short circuit to a higher voltage, the fuse will limit current flow to a minimal amount, thereby protecting the downstream components from excessive current. In parallel, a shunt component, such as Zener diode, is placed across the output line to ground. This component instantly clamps the voltage to a safe level, preventing instantaneous damage to the circuit before the fuse can fully engage.

### Low Output Impedance Design for Long-Distance Signal Transmission:

The disclosure employs a very low output impedance design, allowing the data signal integrity to be maintained over long wiring distances without significant degradation. The low impedance minimizes the effect of parasitic capacitance present in long multi-conductor wire runs, ensuring that the signal remains reliable, even over extended distances. This feature is particularly beneficial in large installations where the lighting controller may be located far from the light fixtures.

The low output impedance is achieved by using robust driver circuits capable of sourcing and sinking the necessary current to maintain signal integrity over long distances. The driver circuit is designed to overcome the parasitic capacitance and inductance of the wiring, ensuring that the signal maintains its integrity from the controller to the lighting fixtures.

### Edge Rate Limiting Filtering for Emissions Compliance:

To ensure compliance with FCC Class B emissions standards, the output section includes a filter that limits the edge rates of the data signal. By controlling the rise and fall times of the signal, the filter reduces higher order harmonics that contribute to electromagnetic interference (EMI). This not only helps in passing regulatory emissions tests but also reduces the potential for interference with other electronic devices in the vicinity.

The filter is designed using a combination of resistors and capacitors to control the slew rate of the data signal. By carefully tuning the filter components, the edge rates of the signal are limited to a range that minimizes higher order harmonic generation. This results in a cleaner signal with reduced EMI, making the system compliant with FCC Class B emissions standards.

### Advantages of the Smart Light Controller

According to the disclosure, the smart light controller provides the following advantages:
Increased Durability: The protection mechanisms significantly reduce the risk of damage due to electrical faults, extending the lifespan of the controller.
Enhanced Signal Integrity: The low output impedance allows for reliable signal transmission over long distances, making the system suitable for large-scale installations.
Regulatory Compliance: The edge rate filtering ensures that the system meets FCC Class B emissions standards, reducing the risk of interference with other devices.

According to the disclosure, a novel outdoor lighting system that integrates modern smart technology with durable, visually integrated hardware is disclosed. The system is designed for permanent installation, offering customizable, app-controlled lighting solutions with a color-matched aluminum track for enhanced aesthetic appeal.

According to the disclosure, the smart lighting controller output section described herein provides significant advancements in terms of protection, performance, and regulatory compliance. This invention is particularly useful in applications where reliability, long-distance signal transmission, and adherence to emissions standards are critical.

According to the disclosure, an outdoor lighting system configured for controlling outdoor lights of a building is disclosed. The outdoor lighting system comprises one or more light emitting diode (LED) light source, a mobile application on a mobile device for controlling colors and patterns on the LED light source, a control box connected to a WiFi network of the building and configured to send data to the LED light source via a 1-wire interface, a computer server in communication with the mobile application and transmitting commands to the control box and an aluminum track mounted on the building to house the LED light source.

According to the disclosure, the aluminum track of the system is configured to color-matched the building to which it is mounted. The mobile application of the system is configured to control different zones of addressable LEDS of the outdoor lights at the building. Furthermore, the mobile application allows for the selection and customization of lighting patterns and effects.

According to the disclosure, the LED light source of the system is individually addressable and can display different colors and effects. The aluminum track of the system provides a secure mounting surface for the LED light source and is color-matched to the installation surface.

According to the disclosure, the system is powered from one to many class-2 power supplies that are electronically isolated from each other, and LED light source control data is passed between the sections via one or more isolators. The one or more LED light source is connected as a LED light string. The LED light source is round and waterproof and mounted on the aluminum track. Furthermore, the aluminum track is mounted on the building to house the LED light source at an interval of 6 to 12 inches apart.

According to the disclosure, the outdoor lighting system further comprises a database, the database configured to store data relating to different light colors and patterns and zones. The different zones configured as events and can be scheduled on different days and time.

According to the disclosure, the outdoor lighting system further comprises an auxiliary power unit, the auxiliary power unit configured to provide additional power for a larger outdoor light system installation, and the auxiliary power unit is connected to the control box and an isolator circuit.

According to the disclosure, a computer-implemented method of creating and scheduling custom lighting events for an outdoor lighting system of a building is disclosed. The outdoor lighting system comprising one or more lighting sources, a mobile light controlling application on a mobile device, a control box and a computer server.

The computer-implemented method comprising the steps of signing onto the mobile light controlling application on the mobile device, creating a building profile, customizing different light colors and patterns to the building profile, creating one or more lighting events, scheduling the one or more lighting events at different times of the day and days of the year, saving the one or more lighting events on the mobile device, sending the one or more lighting event data to the computer server and the control box, and programming the control box to schedule the one or more lighting events.

According to the disclosure, the mobile light controlling application of the method further comprises a color palette to select colors for the LED lighting sources. The mobile light controlling application of the method further comprises a pattern settings screen and options to select brightness, speed and density of patterns.

According to the disclosure, a smart lighting controller for an outdoor lighting system having an output interface is disclosed. The output interface of the smart lighting controller comprises a PPTC resettable fuse for protecting the output line from overcurrent conditions, a voltage shunting mechanism for diverting instantaneous excessive voltage to ground during a short circuit event to higher voltage, a low output impedance driver circuit for maintaining signal integrity over long wiring distances, and an edge rate limiting filter to control signal rise and fall times, thereby reducing electromagnetic interference and ensuring compliance with FCC Class B emissions standards.

According to the disclosure, the voltage shunting mechanism of the smart lighting controller comprises a Zener Diode. Furthermore, the edge rate limiting filter of the smart lighting controller further comprises a combination of resistors and capacitors.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. An outdoor lighting system, the system configured for controlling outdoor lights of a building, the system comprising:
one or more light emitting diode (LED) light source;
a mobile application on a mobile device for controlling colors and patterns on the LED light source;
a control box connected to a WiFi network of the building and configured to send data to the LED light source via a 1-wire interface;
a computer server in communication with the mobile application and transmitting commands to the control box; and
an aluminum track mounted on the building to house the LED light source;
wherein the aluminum track is configured to color-matched the building to which it is mounted;
wherein the mobile application is configured to control different zones of addressable LEDS of the outdoor lights at the building.

2. The outdoor lighting system of claim 1 wherein the mobile application allows for the selection and customization of lighting patterns and effects.

3. The outdoor lighting system of claim 1 wherein the LED light source is individually addressable and can display different colors and effects.

4. The outdoor lighting system of claim 1 wherein the aluminum track provides a secure mounting surface for the LED light source and is color-matched to the installation surface.

5. The outdoor lighting system of claim 1 wherein the system is powered from one to many class-2 power supplies that are electronically isolated from each other, and LED light source control data is passed between the sections via one or more isolators.

6. The outdoor lighting system of claim 1 wherein the one or more LED light source is connected as a LED light string.

7. The outdoor lighting system of claim 1 wherein the LED light source is round and waterproof and mounted on the aluminum track.

8. The outdoor lighting system of claim 1 further comprising a database, the database configured to store data relating to different light colors and patterns and zones.

9. The outdoor lighting system of claim 1 wherein the different zones configured as events and can be scheduled on different days and time.

10. The outdoor lighting system of claim 1 further comprising an auxiliary power unit, the auxiliary power unit configured to provide additional power for a larger outdoor light system installation, and the auxiliary power unit is connected to the control box and an isolator circuit.

11. The outdoor lighting system of claim 1 wherein the aluminum track is mounted on the building to house the LED light source at an interval of 6 to 12 inches apart.

12. A computer-implemented method of creating and scheduling custom lighting events for an outdoor lighting system of a building, the outdoor lighting system comprising one or more lighting sources, a mobile light controlling application on a mobile device, a control box and a computer server, the method comprising the steps of:
signing onto the mobile light controlling application on the mobile device;
creating a building profile;
customizing different light colors and patterns to the building profile;
creating one or more lighting events;
scheduling the one or more lighting events at different times of the day and days of the year;
saving the one or more lighting events on the mobile device;
sending the one or more lighting event data to the computer server and the control box; and
programming the control box to schedule the one or more lighting events.

13. A computer-implemented method of claim 12 wherein the mobile light controlling application further comprises a color palette to select colors for the LED lighting sources.

14. A computer-implemented method of claim 12 wherein the mobile light controlling application further comprises a pattern settings screen and options to select brightness, speed and density of patterns.

15. A smart lighting controller for an outdoor lighting system having an output interface, the output interface of the smart lighting controller comprising:
a PPTC resettable fuse for protecting the output line from overcurrent conditions;
a voltage shunting mechanism for diverting instantaneous excessive voltage to ground during a short circuit event to higher voltage;
a low output impedance driver circuit for maintaining signal integrity over long wiring distances; and
an edge rate limiting filter to control signal rise and fall times, thereby reducing electromagnetic interference and ensuring compliance with FCC Class B emissions standards.

16. The smart lighting controller of claim 15 wherein the voltage shunting mechanism comprises a Zener Diode.

17. The smart lighting controller of claim 15 wherein the edge rate limiting filter further comprises a combination of resistors and capacitors.
